(19) United States
(12) Patent Application Publication
(10) Pub. No.: US 2011/0174588 A1
(43) Pub. Date: Jul. 21, 2011

(54) CLUTCH ASSEMBLY

(75) Inventors: Servet Yildiz, Gensingen (DE); Michael Kiefer, Zornheim (DE); Axel Geiberger, Mainz (DE)

(73) Assignee: GM GLOBAL TECHNOLOGY OPERATIONS LLC, Detroit, MI (US)

(21) Appl. No.: 13/122,048

(22) PCT Filed: Aug. 12, 2009
(86) PCT No.: PCT/EP2009/005843

§ 371 Date: Mar. 31, 2011

(30) Foreign Application Priority Data
Oct. 1, 2008 (GB) 0817937.6

(51) Int. Cl. F16D 13/22; B23P 15/14

(52) U.S. Cl. 192/66.1; 29/893.1

(57) ABSTRACT

A clutch assembly includes, but is not limited to a clutch device and a flywheel. The flywheel is joined to the clutch device by fasteners. The fasteners fasten the flywheel to the clutch device in longitudinal axes of the fasteners respectively. The longitudinal axes of the fasteners are lateral to an axis of rotation of the flywheel.

### CROSS-REFERENCE TO RELATED APPLICATION

This application is a U.S. National-Stage entry under 35 U.S.C. §371 based on International Application No. PCT/EP2009/005843, filed Aug. 12, 2009, which was published under PCT Article 21(2) and which claims priority to British Application No. 0817937.6, filed Oct. 1, 2008, which are all hereby incorporated in their entirety by reference.

### TECHNICAL FIELD

The present invention relates to a clutch assembly for automobiles.

### BACKGROUND

A clutch assembly transmits torque between an engine and a gearbox. The clutch assembly comprises a single clutch and a dual clutch. A single clutch can be engaged to transmit torque between a crankshaft of the engine and an input shaft of the gearbox. Once engaged, the two shafts are connected and spin at the same speed. The single clutch can also be disengaged so that the two shafts are disconnected and spin at different speeds. On the other hand, a dual clutch can be engaged to transmit torque from the crankshaft to one of the two input shafts of the gearbox. There exists a need to make the clutch assembly to be compact and easily accessed inside a closely fitted clutch casing.

### SUMMARY

According to the application, a clutch assembly comprises a clutch device and a flywheel. The flywheel is joined to the clutch device by one or more fasteners. In an ordinary case, several fasteners are distributed around the axis of rotation evenly for fastening the flywheel to the clutch device. In a special case, one fastener is sufficient to fasten the flywheel to the clutch device. One of the fasteners fastens the flywheel to the clutch device in a longitudinal axis of the fastener. A screw is a form of the fastener whose longitudinal axis is an axis of rotation of the screw for tightening. The clutch assembly is configured to output the driving torque to an input shaft of a gearbox. In a single clutch, the clutch device may comprise a pressure plate and a clutch disc, except the flywheel. In a dual clutch, the clutch device may comprise an inner clutch, an outer clutch, and pressure plates, except the flywheel.

The longitudinal axis of the fastener is not parallel to the axis of rotation. In other words, the longitudinal axis of the fastener is lateral to the axis of rotation. This provides the possibility of accessing the fasteners in a direction that is other than directions parallel to the axis of rotation. Therefore, lateral areas of the clutch assembly can be utilised for accessing the fastener with reduced obstruction from a lateral side. For example, the flywheel can be assembled from the lateral side by a screw with little constrain along the axis of rotation.

The longitudinal axis of the fastener may be in a rotation plane of the flywheel. The rotation plane is perpendicular to the axis of rotation. The fastener can be parallel to the rotation plane. This arrangement is efficient in proving the fastening because this arrangement can require the least clearance in the axis direction of the clutch assembly.

The longitudinal axis of the fastener may be perpendicular to a direction of centrifugal force of the fastener when the clutch assembly rotates around the axis of the rotation. In other words, the longitudinal axis of the fastener may be tangential to a circle whose radius represents the minimum distance from the axis of rotation to the longitudinal axis of the fastener. The longitudinal axis of the fastener is provided inside the rotation plane. If the longitudinal direction of the fastener intersects with the axis of rotation, centrifugal force may cause the loosening of the fastener. In contrast, when the fastener is tangentially provided, the centrifugal force of the clutch assembly during rotation will be perpendicular to the longitudinal axis of the fastener. Thus, the loosening effect of the centrifugal force is reduced.

The fastener may be in the form of a screw. The screw is a highly standardised item that can be used in variety of applications. The screw is also used for fastening the clutch assembly due to its long-term reliability.

If the fastener may also be in the form of a rivet. The rivet provides a rigid joint between two parts. The rivet is convenient to apply and has a low implementation cost.

The fastener may be provided near a circumference of the flywheel, thus occupying little space and avoid obstruction to other components of the clutch assembly that requires clearance to rotate. A distance from the fastener to the circumference is closer than to the rotation axis of the clutch assembly.

The clutch assembly may comprise a dual clutch. Space constrain is more severe for the dual clutch. There are more components provided inside a housing of the dual clutch. If designed properly, the fastener that provides fastening in the lateral direction thereby causing less obstruction in the axial direction.

The clutch assembly may also comprise a single clutch. Fasteners that fasten the clutch assembly in a lateral direction provide more flexibility in designing the single clutch in the directions of the axis of rotation.

The clutch assembly may also comprise a pressure plate. The pressure plate is fastened to the clutch device by one or more fasteners. Typically, several fasteners fasten the pressure plate and to the clutch device in a longitudinal axes of the fasteners. The longitudinal axes of the fasteners are lateral to the axis of rotation. Several components of the clutch device can be fastened to the flywheel in a lateral direction. Greater design freedom is further provided the rotation axis direction.

The clutch assembly may further comprise a casing that is closely fitted to the clutch assembly. The closely fitted casing offers more space for other parts of the automobile. The closely fitted casing also limits space required for accessing the fasteners. When the fasteners can be accessed laterally to the axis of rotation, a mechanic has much easier access to the fastener.

The casing may comprise an opening for accessing the fastener from an exterior of the clutch assembly. The opening provides an external access to the fastener with little obstruction in the axial direction that is parallel to the axis of rotation. A dropped screw inside the casing can be easily removed via the opening.

The application provides a clutch assembly for outputting the driving torque to an input shaft of a gearbox. The clutch assembly comprises a disc component that rotates around a rotation axis of the clutch assembly. The disc component is fastened to the clutch device in a direction that is lateral to the axis of rotation. The disc component can comprise any component of the clutch assembly that rotates around the axis. The lateral connection of the fastener enables a mechanic to access the fastener from a lateral side of the clutch assembly with much convenience.

The clutch assembly may comprise a fastener that fastens the disc component to the clutch device in a longitudinal axis of the fastener. The longitudinal axis of the fastener is lateral to the axis of rotation. Being non-parallel to the axis of rotation of the clutch assembly, a mechanic can access the fastener with reduced obstruction in the directions of axis of rotation.

The application provides a power train that comprises the clutch assembly. Lateral access to the fastener of the power train provides convenience.

The application provides an automobile that comprises the clutch assembly. The automobile with the feasibility of laterally accessible fastener on the clutch assembly provides easy access for assembling and maintenance.

The application provides a method of assembling a power train. The method comprises a first step of providing an engine with a flywheel. The flywheel is pre-installed onto a crankshaft of the engine. The method further comprises a second step of connecting a clutch device to the flywheel. In a single clutch this can be connecting a clutch disc and a pressure plate onto the flywheel. In a dual clutch, this can be connecting two clutches, pressure plates and other parts to the flywheel. A third step of the method is mounting a gearbox onto the clutch device. The gearbox can have one or two input shafts that are connected to the clutch device. Fourthly, the method comprises a step of fastening the flywheel onto the mounted clutch device. The fastening can be performed from lateral access of the power train. When screws are used as the fasteners for the mounting, a mechanic can tighten the screws from a lateral side of the power train, which has little obstruction from the gearbox and the engine in an axial direction of the clutch device.

The application also provides a method of disassembling a power train. The method comprises a first step of loosening a flywheel from a clutch device. A mechanic can loose fasteners of the power train from a lateral side of the clutch device. Other parts of the power train in the axial direction of the clutch device present little obstruction to the loosening. A second step of the method is dismounting a gearbox from the loosened clutch device. A third step of the method is dismounting the loosened clutch device from the flywheel. In these three steps, obstruction in the axial direction of the clutch device is minimised, which is convenient for the disassembling.

### BRIEF DESCRIPTION OF THE DRAWINGS

The present invention will hereinafter be described in conjunction with the following drawing figures, wherein like numerals denote like elements, and:

FIG. 1 illustrates a side view of an exposed dual clutch; and

FIG. 2 illustrates a side view of a cover of the dual clutch.

### DETAILED DESCRIPTION

The following detailed description is merely exemplary in nature and is not intended to limit application and uses. Furthermore, there is no intention to be bound by any theory presented in the preceding background or summary or the following detailed description.

In the following description, details are provided to describe the embodiments of the application. It shall be apparent to one skilled in the art, however, that the embodiments may be practiced without such details.

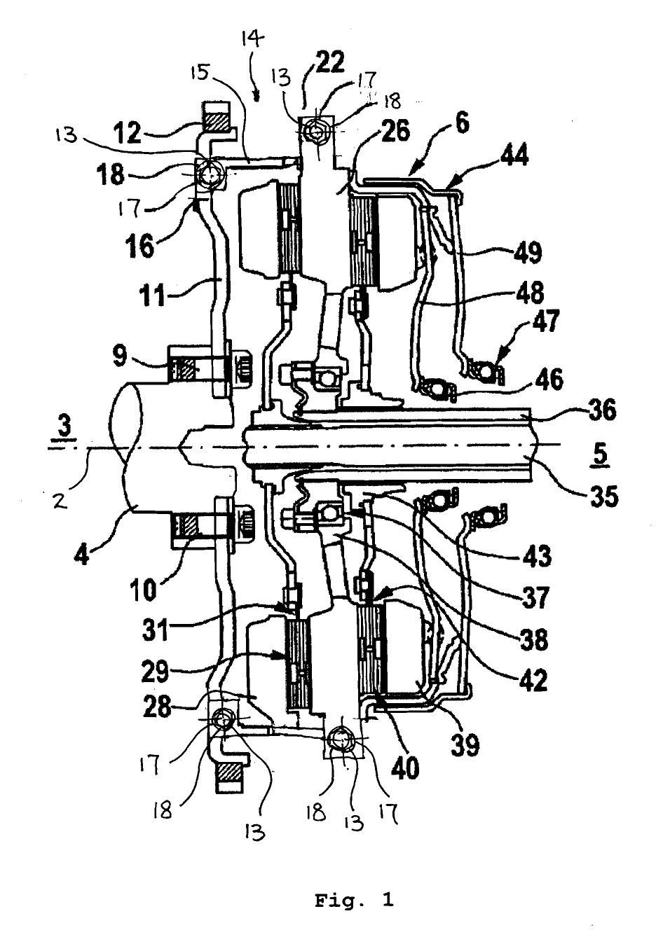

FIG. 1 illustrates a side view of an exposed dual clutch 6. The dual clutch 6 is provided between a combustion engine 3 on the left and a gearbox 5 on the right. The combustion engine 3 and the gearbox 5 are not shown in FIG. 1.

The combustion engine 3 is connected to the dual clutch 6 via a crankshaft 4 (partially shown). The gearbox 5 is connected to the dual clutch 6 via an inner input shaft 35 and an outer input shaft 36. The inner shaft 35 and the outer shaft 36 are connected to two clutches 31, 42 respectively. An inner clutch 31 is connected to the inner input shaft 35 and the outer clutch is connected to the outer input shaft 42. Longitudinal directions of the crankshaft 4, the dual clutch 6, the inner input shaft 35 and the outer input shaft are aligned to an axis 2, which is also the common rotational axis of the crankshaft 4, the dual clutch 6 and the input shafts 35, 36.

The crankshaft 4 of the combustion machine 3 is tightly connected to a flywheel 11 of the dual clutch 6 via screw connections. Only two of the screw connections 9, 10 are visible in FIG. 1. There are six such screw connections that are evenly distributed around the rotation axis 2.

The flywheel 11 is an annular disk extending in radial direction. The flywheel 11 has an outer edge bent uniformly towards the gearbox 5. A sprocket 12 is attached onto the bent outer edge.

The flywheel 11 is attached to an intermediate pressure plate 26 of the dual clutch 6 via a cover 14 in the longitudinal direction. The cover 14 comprises an intermediate ring body 15, in the form of a barrel, which resembles a circular cylinder. On the combustion engine side, the intermediate ring body 15 comprises an attachment lug 16 extending from a peripheral edge of the intermediate ring body 15. The attachment lug 16 comprises a circular through hole 17 that opens in the direction of rotation. Correspondingly, the flywheel 11 comprises a recess that receives the attachment lug 16. In the recess, the flywheel 11 comprises a threaded blind hole such that a screw 13 joins the attachment lug 16 to the flywheel 11 at the threaded hole. The screw 13 connects the attachment lug 16 to the flywheel 11 in a manner that is similar to the screw connections 9, 10. A longitudinal direction of the screw 13 is in a lateral direction with respect to the longitudinal axis 2. In particular, the longitudinal direction of the screw 13 is perpendicular to the longitudinal axis 2 and also lies in a rotational plane of the clutch assembly 6. The rotational plane is perpendicular to the axis of rotation 2. There is provided a spring washer 18 on the attachment lug 16 such that the screw 13 can be loosened together with the spring washer 18.

There are six attachment lugs evenly distributed around the peripheral of the flywheel 11. Each of these six attachment lugs is bolted to the recesses of the flywheel 11 respectively. Spring washers are also provided onto the six attachment lugs.

On the right side of the intermediate ring body 15 towards the gearbox 5, there is further shown an attachment lug 22. The attachment lug 22 comprises a circular through hole that opens in the direction of dual clutch rotation. Correspondingly, there is a recess provided on the intermediate pressure plate 26 for receiving the attachment lug 22. In the recess, the intermediate ring body 15 comprises a threaded blind hole such that a screw 13 joins the attachment lug 22 to the intermediate pressure plate 26 at the threaded hole. A longitudinal direction of the screw 13 is in a lateral direction with respect to the longitudinal axis 2. In particular, the longitudinal direction of the screw 13 is perpendicular to the longitudinal axis 2.

Inside the intermediate ring body 15, friction pads 29 are provided between the intermediate pressure plate 26 and a pressure plate 28 on the left. The friction pads 29 can be forced against the intermediate pressure plate 26 in the axial direction for engaging and for disengaging the intermediate pressure plate 26. The friction pads 29 are provided on two opposite sides of the inner clutch disk 31. The inner clutch disk 31 is non-rotatably connected to the inner input shaft 35, which is in the form of a solid shaft.

The inner input shaft 35 is disposed inside the outer input shaft 36. Both input shafts 35, 36 share the common rotational axis 2. The inner input shaft 35 protrudes outside the outer input shaft 36 at a left end.

A hub part 38 is provided at a left end of the outer input shaft 36. The hub part 38 is connected to outer input shaft 36 via a roller bearing 37. The intermediate pressure plate 26 is mounted on the hub part 38 such that the hub part 38 is able to rotate around the input shafts 35, 36. Friction pads 40 are further provided between the intermediate pressure plate 26 and pressure plate 39. The friction pads 40 are attached onto a second clutch disk 42 on opposite sides of the second clutch disk 42. The second clutch disk 42 is also mounted onto the outer input shaft 36 on a hub part 43.

The dual clutch 6 comprises a clutch lid 44. The clutch lid 44 is attached to both the pressure plates 28, 39 in the axial direction. Furthermore, the intermediate pressure plate 26 is attached to the clutch lid 44. The dual clutch 6 is actuated via actuation means 46, 47 that interact with actuation levers 48, 49.

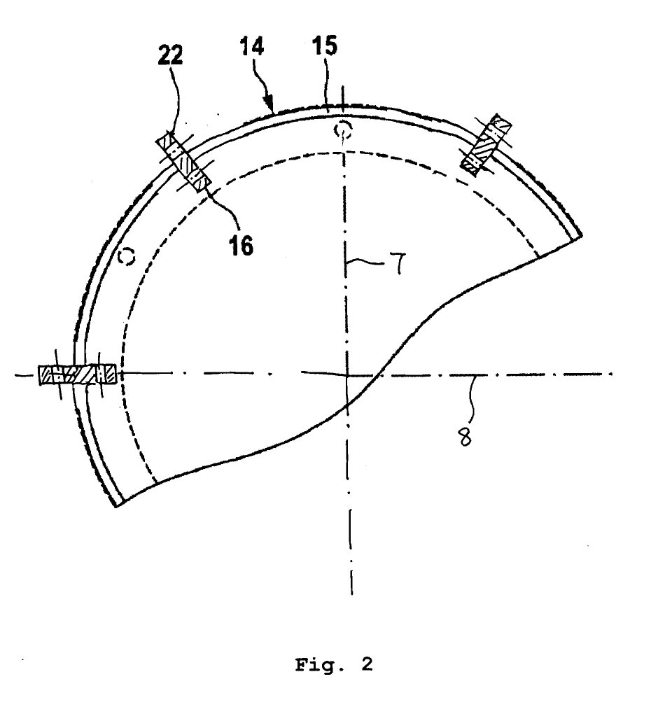

FIG. 2 illustrates a front view of the detached cover 14. The cover 14 comprises six attachment lugs radially extending from its peripheral. The front view only shows three attachment lugs. FIG. 2 also shows a horizontal axis 8 and a vertical axis 7 on the detached cover 14. The horizontal axis 8 and the vertical axis 7 are perpendicular to each other. An intersection of the horizontal axis 8 and a vertical axis 7 is aligned to the longitudinal axis of the cover 14. Longitudinal axes of the attachment lugs are also depicted in FIG. 2. The longitudinal axes of the attachment lugs follow the direction of rotation of the flywheel. The six attachment lugs are evenly distributed such that there is an angle of 60° between every two annually neighbouring attachment lugs.

The screws 13 connect the cover 14 to the flywheel 11 and the intermediate pressure plate 26 laterally with respect to the rotation axis of the dual clutch 6. This arrangement advantageously provides a compact dual clutch. In practise, the dual clutch 6 is enclosed inside a casing that is closely fitted to the dual clutch 6. Little clearance is provided between the casing and the exterior of the dual clutch 6 because the dual clutch has to be made as compact as possible. Since the longitudinal axes of the screws 13 are parallel to the rotational direction of the dual clutch 6, larger screws can be provided because those larger screws can be accessed in radial directions of the dual clutch 6. Openings can be provided on the casing such that the larger screws are more accessible in the radial directions.

In operation, the lateral screw 13 connections almost do not generate noise. In maintenance, magnetic tools for accessing the screws 13 can avoid dropping the screws 13 inside the casing. When an accessed screw is rotated at the bottom of the dual clutch 6, parts of the screw connection will drop out of the casing due gravity, which is desired for taking the screw out of the casing.

Additionally, due to lateral screw connections, the gearbox 5 and the combustion engine 3 can be assembled by force fit and by form fit.

The closely fitted casing demands smaller screws that may reduce reliability of the screw connections. Furthermore, due to the constrain of the closely fitted casing, the screw has to be reduced in threaded length. Once the screws are provided in the lateral direction, longer screws with larger heads can be accepted for a compact dual clutch.

The cover 14 is connected to the flywheel 11 via screws 13. Longitudinal axes of the screws 13 follow the direction of rotation of the dual clutch 6. In other words, the longitudinal axes of the screws are lateral to the rotational axis of the dual clutch. The dual clutch 6 is an example of a clutch assembly. The clutch assembly can be a single clutch or a dual clutch.

The sprocket 12 is also known as a starter ring. The fastener is a hardware device that mechanically joins or affixes two or more objects together. Examples of the fastener comprise bolt, screw, cap screw, stud, button, clamp, cramp, clasp, nail, peg and pin. There can be other number of screws for fastening the cover 14 to the side of the intermediate pressure plate 26 or to side of the flywheel 11. For example, any number of screws from three to eight is suitable for the connections at one of the sides.

Although the above description contains much specificity, these should not be construed as limiting the scope of the embodiments but merely providing illustration of the foreseeable embodiments. Especially the above stated advantages of the embodiments should not be construed as limiting the scope of the embodiments but merely to explain possible achievements if the described embodiments are put into practise. Thus, the scope of the embodiments should be determined by the claims and their equivalents, rather than by the examples given.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A clutch assembly comprising:
a clutch device;
at least one fastener; and
a flywheel joined to the clutch device by the at least one fastener in a longitudinal axis of the at least one fastener,
wherein the longitudinal axis of the at least one fastener is substantially lateral to an axis of rotation of the flywheel.

2. A clutch assembly according to claim 1,
wherein the longitudinal axis is in a rotation plane of the flywheel,
wherein the rotation plane is substantially perpendicular to the axis of rotation of the flywheel.

3. A clutch assembly according to claim 2, wherein the longitudinal axis is substantially perpendicular to a direction of a centrifugal force of the at least one fastener when the clutch assembly rotates around the axis of the rotation.

4. A clutch assembly according to claim 1, wherein the at least one fastener comprises a screw.

5. A clutch assembly according to claim 1, wherein the at least one fastener comprises a rivet.

6. A clutch assembly according to claim 1, wherein the fastener is near a circumference of the flywheel.

7. A clutch assembly according to claim 1 further comprising a dual clutch.

8. A clutch assembly according to claim 1 further comprising a single clutch.

9. A clutch assembly according to claim 1, further comprising:
a pressure plate fastened to the clutch device by a fastener,
wherein the fastener fastens the pressure plate to the clutch device in a longitudinal axis of the fastener,
wherein the longitudinal axis of the at least one fastener being lateral to the axis of rotation.

10. A clutch assembly claim 1, further comprising a casing closely fitted to the clutch assembly.

11. A clutch assembly according to claim 10, wherein the casing comprises an opening for laterally accessing the fastener from an exterior of the clutch assembly.

12. A power train comprising the clutch assembly according to one of the aforementioned claims.

13. (canceled)

14. A method of assembling a power train comprising:
providing an engine with a flywheel;
connecting a clutch device to the flywheel;
mounting a gearbox onto the clutch device; and
fastening the flywheel onto the mounted clutch device.

15. A method of disassembling a power train comprising:
loosening a flywheel from a clutch device;
dismounting a gearbox from the loosened clutch device; and
dismounting the loosened clutch device from the flywheel.
